(19) United States
(12) Patent Application Publication
(10) Pub. No.: US 2019/0193113 A1
(43) Pub. Date: Jun. 27, 2019

(54) IRRADIATION SYSTEMS FOR CURING TARGETS, RELATED CURING SYSTEMS, AND RELATED METHODS

(71) Applicants: Heraeus Noblelight America LLC, Gaithersburg, MD (US); Heraeus Noblelight GmbH, Hanau (DE)

(72) Inventors: William E. Johnson, III, Burke, VA (US); Darrin Leonhardt, Gaithersburg, MD (US); Ruben C. Manikkam, Clarksburg, MD (US); David A. Sprankle, Hagerstown, MD (US); Mahmood Gharagozloo, Gaithersburg, MD (US); Brett Skinner, Silver Spring, MD (US); Michael K. West, Beltsville, MD (US); Brad Cohen, Smithsburg, MD (US); Jochen Grade, Frankfurt (DE)

(21) Appl. No.: 16/220,401

(22) Filed: Dec. 14, 2018

Related U.S. Application Data
(60) Provisional application No. 62/609,968, filed on Dec. 22, 2017.

(51) Int. Cl. B05D 3/06; C03C 25/6226; C03C 25/6213; H05B 33/08; F21V 7/00

(52) U.S. Cl. CPC B05D 3/067; C03C 25/6226; F21V 7/0083; H05B 33/0824; C03C 25/6213

(57) ABSTRACT

An irradiation system is provided. The irradiation system includes a plurality of LED arrays, each of the LED arrays including a plurality of LED light producing elements. The irradiation system also includes a target area, the target area being adapted to receive light energy from each of the plurality of LED arrays. The plurality of LED arrays are positioned with respect to one another such that they surround the target area of the irradiation system.

### CROSS-REFERENCE TO RELATED APPLICATION

This application claims the benefit of U.S. Provisional Patent Application No. 62/609,968, filed Dec. 22, 2017, the content of which is incorporated herein by reference.

### FIELD

The invention relates to curing of targets, and more particularly, to improved LED based irradiation systems for curing of such targets.

### BACKGROUND

Aspects of conventional lighting and/or curing systems are disclosed in U.S. Pat. Nos. 8,357,878, 9,648,705, U.S. Patent Application Publication No. 2013/0010460, and U.S. Patent Application Publication No. 2013/0114263.

It would be desirable to provide improved irradiation systems for curing targets, and methods of designing the same.

### SUMMARY

According to an exemplary embodiment of the invention, an irradiation system is provided. The irradiation system includes a plurality of LED arrays, each of the LED arrays including a plurality of LED light producing elements. The irradiation system also includes a target area, the target area being adapted to receive light energy from each of the plurality of LED arrays. The plurality of LED arrays are positioned with respect to one another such that they surround the target area of the irradiation system.

According to another exemplary embodiment of the invention, a curing system for curing a target is provided. The curing system includes a coating system for coating a target, and an irradiation system for curing the target after the target is coated using the coating system. The irradiation system includes (i) a plurality of LED arrays, each of the LED arrays including a plurality of LED light producing elements, and (ii) a target area, the target area being adapted to receive light energy from each of the plurality of LED arrays, wherein the plurality of LED arrays are positioned with respect to one another such that they surround the target area of the irradiation system.

According to yet another exemplary embodiment of the invention, a method of designing an irradiation system is provided. The method includes the steps of: (a) providing a target configured for curing using the irradiation system; (b) determining curing characteristics for curing the target, the curing characteristics including at least one of (i) a desired level of irradiation for curing the target and (ii) a target area for receiving energy from the irradiation system; (c) using the curing characteristics to determine a plurality of LED arrays for inclusion in the irradiation system, each of the LED arrays including a plurality of LED light producing elements; and (d) positioning the plurality of LED arrays with respect to one another such that they surround the target area of the irradiation system.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1A is a block diagram of an optical fiber curing system in accordance with an exemplary embodiment of the invention;

FIG. 1B is a block diagram of an target curing system in accordance with an exemplary embodiment of the invention;

FIG. 2 is a partially exploded, perspective view of elements of an irradiation system in accordance with an exemplary embodiment of the invention;

FIG. 3A is a block diagram, end view of elements of another irradiation system in accordance with an exemplary embodiment of the invention;

FIG. 3B is another block diagram, internal view, of elements of the irradiation system of FIG. 3A;

FIG. 3C is a side view of a lens element of the irradiation system of FIG. 3A;

FIG. 4A is a block diagram, end view, of elements of yet another irradiation system in accordance with an exemplary embodiment of the invention;

FIG. 4B is another block diagram, internal view, of elements of the irradiation system of FIG. 4A; and

FIG. 5 is a flow diagram illustrating a method of designing an irradiation system in accordance with an exemplary embodiment of the invention.

### DETAILED DESCRIPTION

According to aspects of the invention, the lamp/irradiator used to cure a target is designed (e.g., shaped, configured, etc.) to address the specific target requiring curing. This is accomplished, for example: by the placement of the light producing elements/arrays that perform the curing operation (e.g., to surround the target); by the inclusion of specific optical elements (e.g., reflectors, lenses, etc.) placed with respect to the light producing arrays and the target; by the inclusion of reflectors between the light producing arrays; among other features.

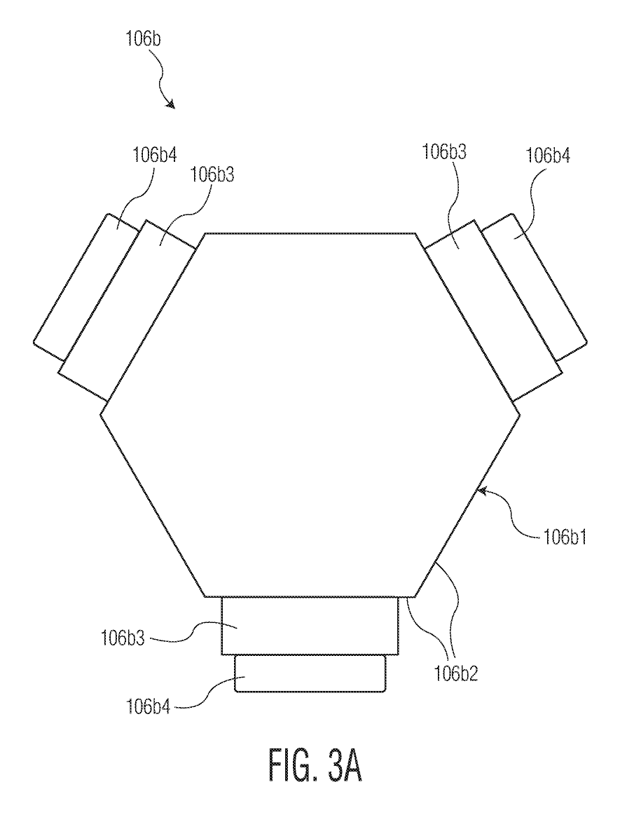

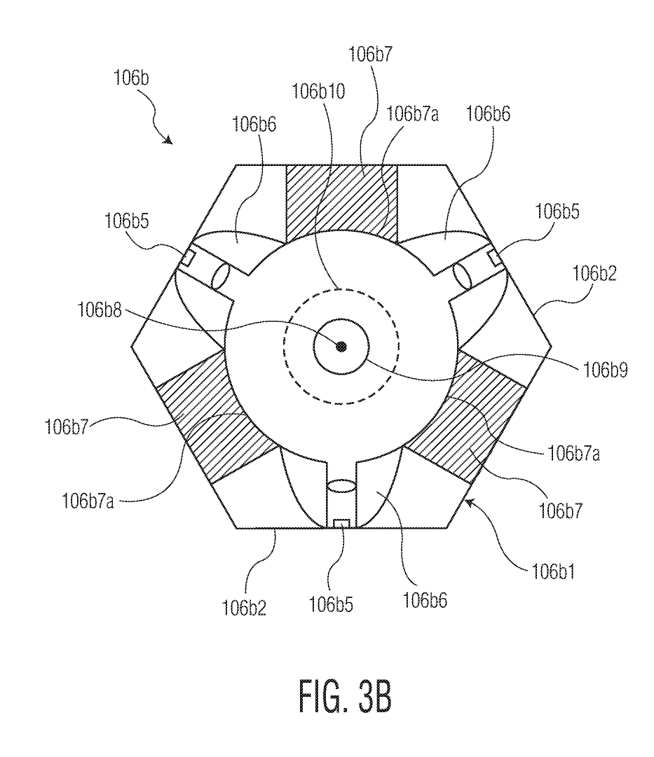

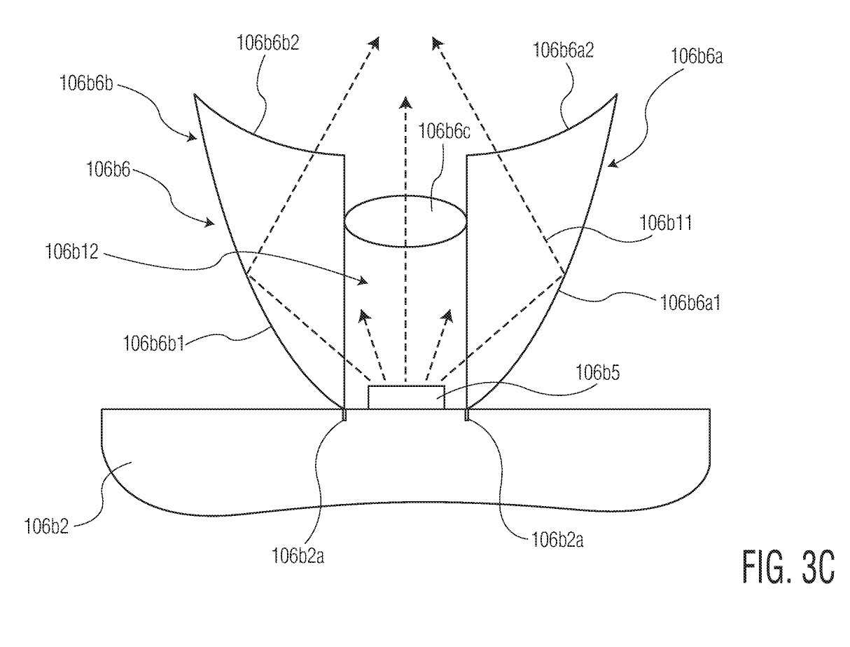

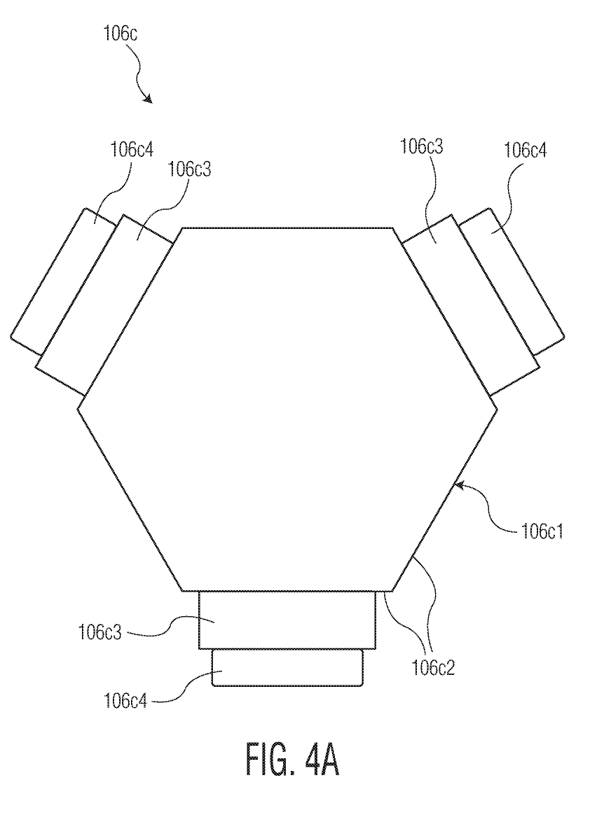

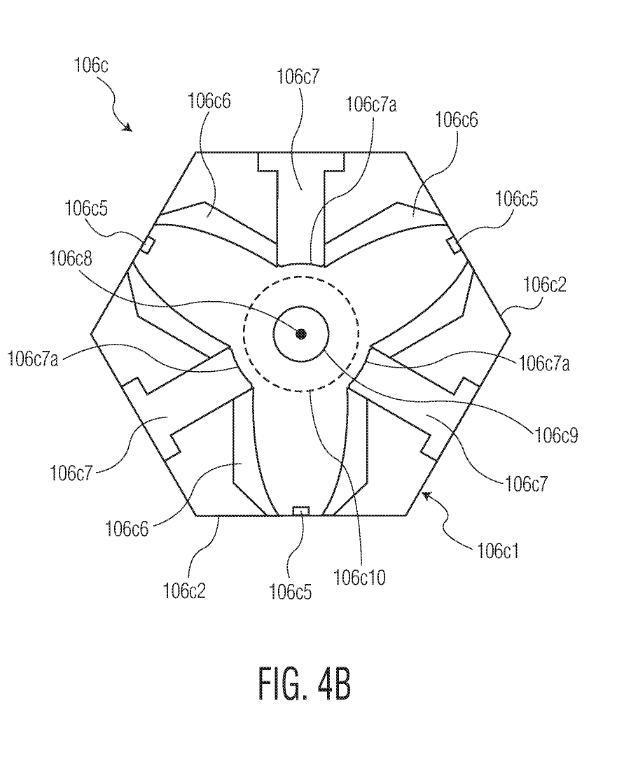

In certain aspects of the invention, the irradiator/lamp may be mounted on a rotating structure/platen. This permits the irradiator/lamp to be turned during servicing. The lenses (e.g., see FIGS. 3B and 3C), and the reflectors (see FIG. 3B, FIG. 4B) positioned between the LED arrays, are both desirably configured to be easily installed and removed. Likewise, the LED arrays may be configured to be easily removed and replaced.

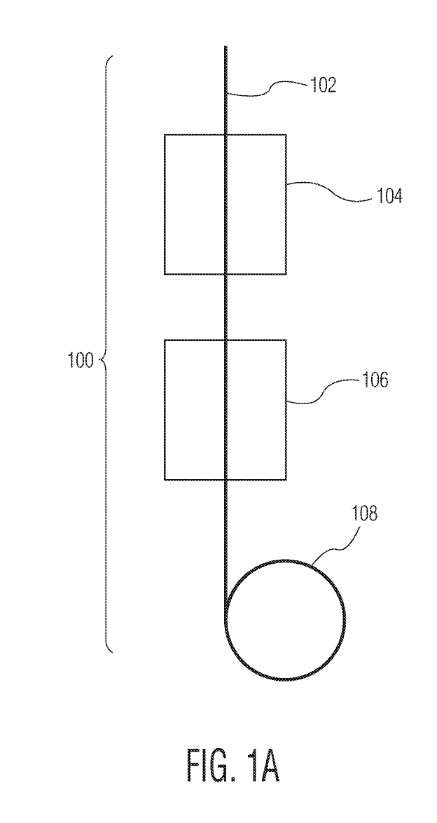

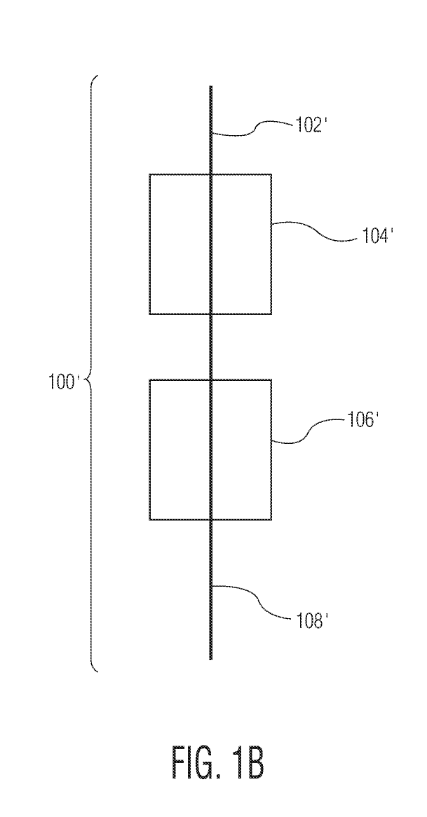

Referring now to the drawings, FIG. 1A illustrates an optical fiber curing system 100. Optical fiber curing system 100 includes a source optical fiber 102, a coating system 104, an irradiation system 106 (also referred to herein as an irradiator), and a spool 108. Source optical fiber 102 is coated at coating system 104, and then the coating is cured using irradiation system 106, and then the coated/cured optical fiber is wound on spool 108. Aspects of the invention described herein relate particularly to irradiation system 106.

While the invention has applicability to optical fiber curing systems (such as optical fiber curing system 100 shown in FIG. 1A), the invention is applicable to irradiation systems (and curing systems) for many applications. For example, other targets (other than optical fiber) may be processed using such irradiation systems. Exemplary targets include pipes, cables, ribbon, wire, etc. for which curing of a coating is desired. FIG. 1B illustrates a generic target curing system 100′ for curing such targets. Target curing system 100′ includes a target 102′, a coating system 104′, and an irradiation system 106′ (also referred to herein as an irradiator). Target 102′ (e.g., a pipe, a cable, or other target) is coated at coating system 104′, and then the coating is cured using irradiation system 106′.

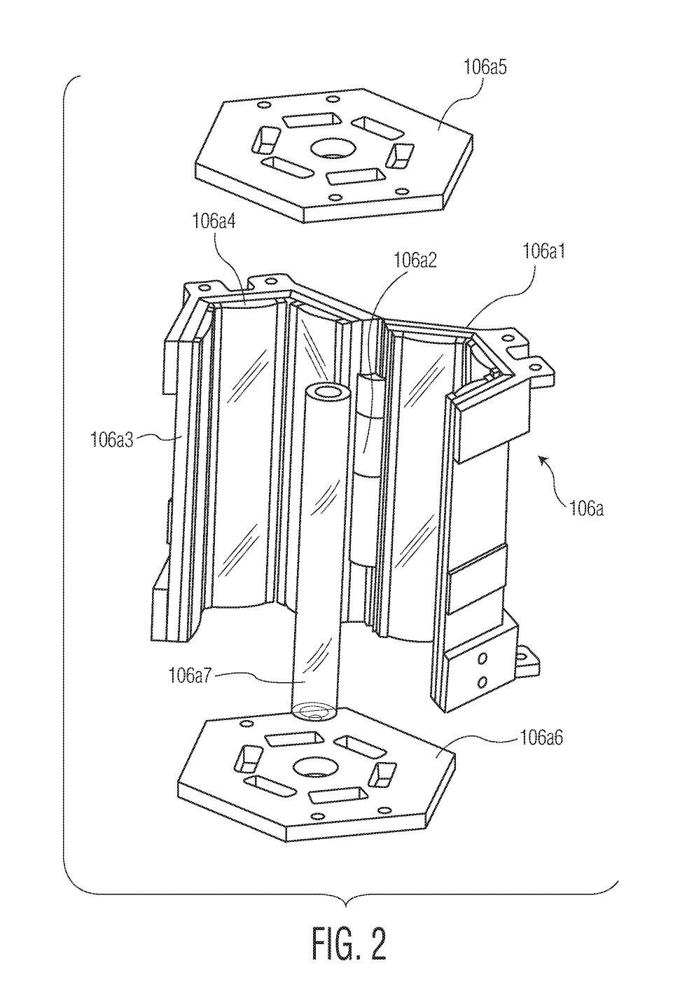

Irradiation systems 106/106′ may vary within the scope of the invention described and claimed herein. FIG. 2 illustrates one exemplary irradiation system 106a; FIGS. 3A-3C illustrate another exemplary irradiation system 106b; and FIGS. 4A-4B illustrate yet another exemplary irradiation system 106c. Either of irradiation systems 106, 106′ from FIGS. 1A-1B could be any of irradiation systems 106a (FIG. 2), 106b (FIGS. 3A-3C), 106c (FIG. 4A-4B), or any other irradiation system within the scope of the invention. Elements from each of FIG. 2, FIGS. 3A-3C, and FIGS. 4A-4C may be combined, as desired.

Referring now specifically to FIG. 2, an irradiation system 106a is shown in a partially exploded view. Irradiation system 106a includes a housing 106a1, and substrate walls 106a3. One or more hinges 106a2 connect sections of housing 106a1 including substrate walls 106b2. End caps 106a5, 106a6 are provided on each terminal end of housing 106a1. Inside housing 106a1, on substrate walls 106a3, are provided a plurality of LED arrays 106a4, where each of the LED arrays 106a4 includes a plurality of LED light producing elements (e.g., ultraviolet LED light producing elements, infrared LED light producing elements, etc., where such elements are not individually labelled in the drawings because of size). The plurality of LED arrays 106a4 are arranged to surround quartz tube 106a7 (which is configured to house a target, such as an optical fiber, where this tube, and other tubes described herein, may be filled with a gas such as nitrogen or argon in order to purge oxygen to improve curing efficiency due to the mitigation of oxygen inhibition in the photopolymerization reaction, during irradiation by irradiation system 106a). In FIG. 2, six (6) different LED arrays 106a4 are provided (one on each substrate wall 106a3) to surround quartz tube 106a7. However, in accordance with the invention, any number of LED arrays (such as LED arrays 106a4) may be provided to surround the target (such as the target housed within quartz tube 106a7).

For example, in a configuration different from that shown in FIG. 2, three (3) LED arrays 106a4 may be provided to surround quartz tube 106a7 (e.g., in each of FIGS. 3A-3C, and FIGS. 4A-4B, three LED arrays are provided to surround the target). Returning again to FIG. 2, additional optical elements (e.g., lenses, reflectors, etc.) may be provided, as desired to optimize the specific application. For example, lenses may be between each of the LED arrays and the quartz tube (e.g., see lenses 106b6 in FIGS. 3B-3C). Further, reflectors may be provided between each of the LED arrays (e.g., see reflectors 106b7 in FIG. 3B, or reflectors 106c7 in FIG. 4B). Further still, primary reflectors may be provided adjacent each LED array to direct light energy toward a target (e.g., see primary reflectors 106c6 in FIG. 4B). When irradiation system 106a is fully assembled (or an irradiation system similar irradiation system 106a, but with a different number of LED arrays, and/or with any of the aforementioned lenses or reflectors), a coated optical fiber (or other target) enters irradiation system 106a via a hole in one end cap 106a5 or 106a6, passes through quartz tube 106a7, and exits irradiation system 106a via a hole in the other end cap 106a5 or 106a6. Through the operation of the LED arrays, the coating previously applied to the target is desirably cured while in quartz tube 106a7.

FIG. 3A illustrates a simplified, end view, of an irradition system 106b (the elements within the enclosure are removed for simplicity, but see FIG. 3B). Irradiation system 106b includes a housing 106b1 (which may be similar to housing 106a1 in FIG. 2, or may vary as desired) including a plurality of wall sections 106b2. While illustrated in a simplified manner, each wall section 106b2 may represent a more complex structure, for example: (i) an outside wall portion/structure and an interior wall portion/structure (e.g, an interior substrate wall similar to substrate wall 106a3 in FIG. 2); or (ii) a part of an underlying housing such as housing 106a1 shown in FIG. 2, that supports substrate sections such as substrate wall 106a2 in FIG. 2.

Irradiation system 106b includes three (3) light producing arrays 106b5 (e.g., LED arrays including a plurality of LED light producing elements), which are visible in FIGS. 3B-3C. As shown in FIG. 3A (when viewed in connection with FIG. 3B), a heatsink 106b3 along with a corresponding cooling element 106b4 (e.g., a fan), is provided on each of the wall sections 106b2 that supports a light producing array 106b5 (e.g., an LED array).

FIG. 3B is another end view of irradiation system 106b, but that shows certain of the internal elements thereof. In the example shown in FIG. 3B, three (3) light producing arrays 106b5 (e.g., LED arrays) are provided, and are positioned with respect to one another to surround a target area 106b10 and a target 106b8. In the example shown in FIG. 3B, target 106b8 (e.g., an optical fiber) is provided in a target housing 106b9 (e.g., a quartz tube, as in FIG. 2). A desired optical boundary limitation 106b10 (e.g., also referred to as target area 106b10 for receiving a predetermined level, or profile, of irradiation) is also shown around target 106b8 and target housing 106b9.

Light producing arrays 106b5 (e.g., LED arrays) are each provided on internal portions of wall sections 106b2. A lens element 106b6 (also referred to as an optical lens 106b6, detailed in FIG. 3C) is positioned between each of the light producing arrays 106b5 (e.g., LED arrays) and target 106b10 (and target 106b8). Optical reflectors 106b7, each including an internal curved surface 106b7a (e.g., for reflecting light back toward target area 106b10 and target 106b8), are provided between each of lens elements 106b6. Light from each light producing array 106b5 passes through a respective lens element 106b6, and then on to target area 106b10 (and target 106b8). The inclusion of optical reflectors 106b7 between lens elements 106b6, makes irradiation system 106b more efficient. Further, the design of lens elements 106b6 (detailed in FIG. 3C) also makes irradiation system 106b more efficient.

FIG. 3C provides a detailed side view of one of lens elements 106b6 of FIG. 3B, where light from the adjacent light producing array 106b5 passes through lens element 106b6 on the way to target area 106b10. Some of the light goes through the primary (central) lens portion 106b6c, where such light is shown as extending in a vertical direction in the view shown in FIG. 3C. As shown in FIG. 3C, the primary (central) lens portion 106b6c may have a “double convex” profile designed to aim the light to a central region of target area 106b10. The double convex profile means that light enters a first “entry” convex profile of the lens, and is then directed to a second “exit” convex profile of the lens.

In addition to the primary (central) lens portion 106b6c of lens element 106b6, each lens element 106b6 includes a first side portion 106b6a and a second side portion 106b6b. A portion of the light (e.g., illustrated as dotted line 106b11 in FIG. 3C) from light producing array 106b5 also reflects off of the curved side walls 106b6a1, 106b6b1 of each of the side portions 106b6a, 106b6b, and exits lens element 106b6 via curved walls 106b6a2, 106b6b2, on its way to target area 106b10. Specifically, the light that enters curved side walls 106b6a1, 106b6b1 refracts and then interacts with the total internal reflection (TIR) surface of the curved side walls 106b6a1, 106b6b1.

As shown in FIG. 3C, each lens element 106b6 is aligned in grooves 106b2a (or other features) of the respective wall section 106b2, which provides for efficient installation, removal, and alignment. FIG. 3C also illustrates a gap 106b12 between light producing array 106b5 and lens element 106b6 (i.e., lens element 106b6 is spaced apart from the light producing elements of light producing array 106b5). This gap 106b12 allows for efficient cooling of light producing array 106b5.

In accordance with certain exemplary embodiments of the invention, lens elements (e.g., lens elements 106b6 shown in FIGS. 3B-3C) may be formed from at least one of a quartz material and a silicon based material.

In accordance with certain exemplary embodiments of the invention, and in connection with irradiation system 106b shown in FIGS. 3A-3C (and similar irradiation systems), the lens elements may be positioned in a specific location to optimize light energy provided by the light producing arrays based on predetermined criteria. Such predetermined criteria includes at least one of a target location, a target size, a desired area of irradiation around the target, and a desired level of irradiation of the target.

Thus, FIGS. 3A-3C illustrate one detailed example of an irradiation system 106b. FIGS. 4A-4B illustrate another detailed example, through the external (FIG. 4A) and internal (FIG. 4B) views. FIG. 4A illustrates a simplified, end view, of an irradition system 106c (the elements within the enclosure are removed for simplicity, but see FIG. 4B). Irradiation system 106c includes a housing 106c1 (which may be similar to housing 106a1 in FIG. 2, or may vary as desired) including a plurality of wall sections 106c2. While illustrated in a simplified manner, each wall section 106c2 may represent a more complex structure, for example: (i) an outside wall portion/structure and an interior wall portion/structure (e.g, an interior substrate wall similar to substrate wall 106a3 in FIG. 2); or (ii) a part of an underlying housing such as housing 106a1 shown in FIG. 2, that supports a substrate sections such as substrate wall 106a2 in FIG. 2.

Irradiation system 106c includes three (3) light producing arrays 106c5 (e.g., LED arrays), which are visible in FIG. 4B. As shown in FIG. 4A (when viewed in connection with FIG. 4B), a heatsink 106c3 along with a corresponding cooling element 106c4 (e.g., a fan), is provided on each of the wall sections 106c2 that supports a light producing array 106c5 (e.g., an LED array).

FIG. 4B is another end view of irradiation system 106c, but that shows certain of the internal elements thereof. In the example shown in FIG. 4B, three (3) light producing arrays 106c5 (e.g., LED arrays including a plurality of LED light producing elements) are provided, and are positioned with respect to one another to surround a target area 106c10 and a target 106c8. In the example shown in FIG. 4B, target 106c8 (e.g., an optical fiber) is provided in a target housing 106c9 (e.g., a quartz tube, as in FIG. 2). A desired optical boundary limitation 106c10 (e.g., also referred to as a target area 106b10 for receiving a predetermined level, or profile, of irradiation) is also shown around target 106c8 and target housing 106c9.

Light producing arrays 106c5 (e.g., LED arrays) are each provided on internal portions of wall sections 106c2. A primary reflector 106c6 is positioned adjacent each of the light producing arrays 106c5 (e.g., LED arrays), and is configured to direct light energy from the respective one of the plurality of light producing arrays 106c5 toward optical boundary limitation 106c10 (and target 106c8). Optical reflectors 106c7 (also referred to herein as secondary reflectors), each including an internal curved surface 106c7a (e.g., for reflecting light back toward optical boundary limitation 106c10 and target 106c8), are provided between each of primary reflectors 106c6. Light from each light producing array 106c5 passes through (and/or is reflected by) a respective primary reflector 106c6, and then on to optical boundary limitation 106c10 (and target 106c8). The inclusion of optical reflectors 106c7 between primary reflectors 106c6, makes irradiation system 106b more efficient (e.g., because additional light energy is reflected off of curved surface 106c7a, and back toward optical boundary limitation 106c10 and target 106c8).

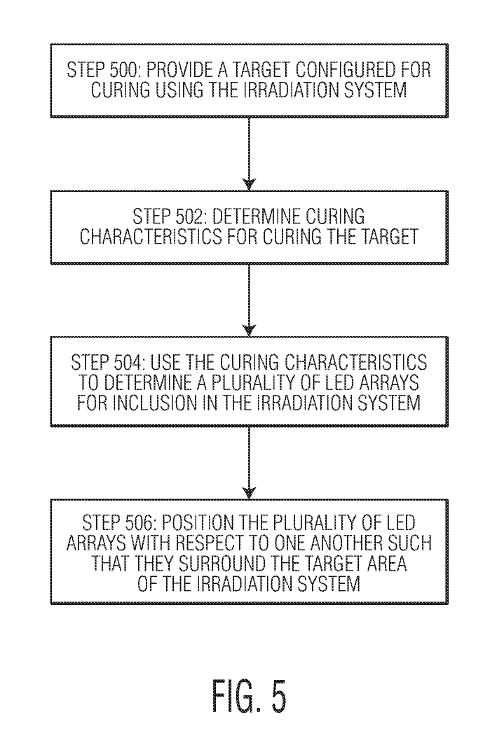

FIG. 5 is a flow diagram illustrating a method of designing an irradiation system for curing a target in accordance with an exemplary embodiment of the invention. As is understood by those skilled in the art, certain steps included in the flow diagram may be omitted; certain additional steps may be added; and the order of the steps may be altered from the order illustrated.

At Step 500, a target configured for curing using the irradiation system is provided. At Step 502, curing characteristics for curing the target are determined. The curing characteristics include at least one of (i) a desired level of irradiation for curing the target and (ii) a target area for receiving energy from the irradiation system. At Step 504, the curing characteristics are used to determine a plurality of LED arrays for inclusion in the irradiation system. At Step 506, the plurality of LED arrays are positioned with respect to one another such that they surround the target area of the irradiation system.

Depending on the specific application, additional steps may be included in the method shown in FIG. 5. For example, in an application including an irradiation system such as that shown and described with respect to FIGS. 3A-3C, the method may also include a step of positioning a lens element (e.g., lens elements 106b6) between each of the LED arrays and the target area. The position of the lens elements may be specified to optimize light energy provided by the LED arrays based on predetermined criteria. Such predetermined criteria includes at least one of a target location, a target size, a desired area of irradiation around the target, and a desired level of irradiation of the target.

In another example, in an application including an irradiation system such as that shown and described with respect to FIGS. 4A-4B, the method may also include the steps of: (i) providing a plurality of primary reflectors, each of the plurality of primary reflectors being configured to direct light energy from a respective one of the plurality of LED arrays toward the target; and providing a plurality of secondary reflectors, each of the plurality of secondary reflectors being positioned between respective ones of the plurality of primary reflectors.

A number of significant benefits are achieved through various exemplary embodiments of the invention such as, for example: improved efficiency in managing heat generated by the light producing elements/arrays, which affords extended LED chip lifetime and the ability for shorter wavelength chips (e.g., UVB and UVC) to be used (which require more cooling than UVA chips); a lamp/irradiator designed according to the target that will be cured (e.g., in an optical fiber curing application, a column of fiber can be cured with a column of light); improved photon management, uniformity, and efficiency at the target; improved curing performance with less radiation/energy; because of light producing arrays surrounding the target, there is essentially 360° direct curing to the target; and modularity in that the design can be easily modified by changing the number of elements (e.g., light sources, lenses, etc.).

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A irradiation system comprising:
a plurality of LED arrays, each of the LED arrays including a plurality of LED light producing elements; and
a target area, the target area being adapted to receive light energy from each of the plurality of LED arrays,
wherein the plurality of LED arrays are positioned with respect to one another such that they surround the target area of the irradiation system.

2. The irradiation system of claim 1 wherein the plurality of LED arrays are ultraviolet LED arrays, and the plurality of LED light producing elements are ultraviolet LED light producing elements.

3. The irradiation system of claim 1 wherein the plurality of LED arrays are infrared LED arrays, and the plurality of LED light producing elements are infrared LED light producing elements.

4. The irradiation system of claim 1 wherein the plurality of LED light producing elements include ultraviolet LED light producing elements and infrared LED light producing elements.

5. The irradiation system of claim 1 wherein the plurality of LED arrays include at least three LED arrays.

6. The irradiation system of claim 1 wherein the plurality of LED arrays includes three LED arrays.

7. The irradiation system of claim 1 further comprising reflector elements positioned between each of the plurality of LED arrays.

8. The irradiation system of claim 1 further comprising a lens element positioned between each of the LED arrays and the target area.

9. The irradiation system of claim 8 wherein the lens element includes (i) a central portion for receiving light from the LED arrays and directing the received light toward the target area, and (ii) side portions for receiving additional light from the LED arrays and directing the received additional light toward the target area.

10. The irradiation system of claim 9 wherein each of the side portions includes a curved side wall for reflecting a portion of the received additional light toward the target area.

11. The irradiation system of claim 1 further comprising a plurality of primary reflectors, each of the plurality of primary reflectors being configured to direct light energy from a respective one of the plurality of LED arrays toward the target area.

12. The irradiation system of claim 11 further comprising a plurality of secondary reflectors, each of the plurality of secondary reflectors being positioned between respective ones of the plurality of primary reflectors.

13. The irradiation system of claim 1 wherein the target area includes a tube configured to receive a length of optical fiber for curing of the optical fiber using the plurality of LED arrays.

14. A curing system for curing a target, the curing system comprising:
a coating system for coating a target; and
an irradiation system for curing the target after the target is coated using the coating system, the irradiation system including (i) a plurality of LED arrays, each of the LED arrays including a plurality of LED light producing elements, and (ii) a target area, the target area being adapted to receive light energy from each of the plurality of LED arrays, wherein the plurality of LED arrays are positioned with respect to one another such that they surround the target area of the irradiation system.

15. The curing system of claim 14 wherein the target is an optical fiber, and the curing system is an optical fiber curing system.

16. The curing system of claim 14 wherein the irradiation system further comprises (iii) a plurality of primary reflectors, each of the plurality of primary reflectors being configured to direct light energy from a respective one of the plurality of LED arrays toward the target area, and (iv) a plurality of secondary reflectors, each of the plurality of secondary reflectors being positioned between respective ones of the plurality of primary reflectors.

17. A method of designing an irradiation system, the method comprising the steps of:
(a) providing a target configured for curing using the irradiation system;
(b) determining curing characteristics for curing the target, the curing characteristics including at least one of (i) a desired level of irradiation for curing the target and (ii) a target area for receiving energy from the irradiation system;
(c) using the curing characteristics to determine a plurality of LED arrays for inclusion in the irradiation system, each of the LED arrays including a plurality of LED light producing elements; and
(d) positioning the plurality of LED arrays with respect to one another such that they surround the target area of the irradiation system.

18. The method of claim 17 further comprising the step of (e) positioning a lens element between each of the LED arrays and the target area.

19. The method of claim 17 further comprising the step of (e) providing a plurality of primary reflectors, each of the plurality of primary reflectors being configured to direct light energy from a respective one of the plurality of LED arrays toward the target.

20. The method of claim 19 further comprising the step of (f) providing a plurality of secondary reflectors, each of the plurality of secondary reflectors being positioned between respective ones of the plurality of primary reflectors.
